(19) United States
(12) Patent Application Publication
(10) Pub. No.: US 2024/0385322 A1
(43) Pub. Date: Nov. 21, 2024

(54) CALCULATION DEVICE

(71) Applicant: TOYOTA JIDOSHA KABUSHIKI KAISHA, Toyota-shi (JP)

(72) Inventors: Daiki YOKOYAMA, Miyoshi-shi (JP); Yasuhiro SAITO, Toyoake-shi (JP)

(73) Assignee: TOYOTA JIDOSHA KABUSHIKI KAISHA, Toyota-shi (JP)

(21) Appl. No.: 18/641,713

(22) Filed: Apr. 22, 2024

(30) Foreign Application Priority Data
May 17, 2023 (JP) 2023-081621
Nov. 7, 2023 (JP) 2023-189981

(51) Int. Cl. G01S 17/08; B60W 50/14; B60W 60/00; G01S 7/497

(52) U.S. Cl. CPC G01S 17/08; B60W 50/14; B60W 60/0015; G01S 7/497; B60W 2050/143; B60W 2050/146; B60W 2420/403; B60W 2420/408; B60W 2556/20

(57) ABSTRACT

A calculation device includes: an acquisition unit that acquires sensor information and equipment information; and a calculation unit that calculates at least one of a position and orientation of a moving object using the sensor information, wherein in a first case where the moving object is equipped with an onboard distance measuring device, the calculation unit uses at least onboard distance measuring device information acquired by the onboard distance measuring device as the sensor information, thereby calculating at least one of the position and the orientation of the moving object, and in a second case where the moving object is not equipped with the onboard distance measuring device, the calculation unit uses, as the sensor information, at least one of image information acquired by an external camera installed in a different location from that of the moving object and external distance measuring device information acquired by an external distance measuring device installed in a different location from that of the moving object, thereby calculating at least one of the position and the orientation of the moving object.

### CROSS-REFERENCE TO RELATED APPLICATIONS

This application claims priority of Japanese Patent Application No. 2023-081621 filed on May 17, 2023 and Japanese Patent Application No. 2023-189981 filed on Nov. 7, 2023, the entire disclosures of which are incorporated herein by reference.

### BACKGROUND

### Field

The present disclosure relates to a calculation device.

### Related Art

Conventionally, a vehicle automatically running by remote control has been known (JP-T-2017-538619).

In a case of moving a moving object such as a vehicle by unmanned driving, it is desired to accurately calculate a position and orientation of the moving object.

### SUMMARY

The present disclosure can be implemented according to the following aspects.
(1) According to a first aspect of the present disclosure, a calculation device is provided. The calculation device includes: an acquisition unit that acquires sensor information acquired by a sensor, and equipment information indicating whether or not a moving object movable by unmanned driving is equipped with an onboard distance measuring device as the sensor mounted on the moving object; and a calculation unit that calculates at least one of a position and orientation of the moving object using the sensor information acquired by the acquisition unit, wherein in a first case where the moving object is equipped with the onboard distance measuring device, the calculation unit uses at least onboard distance measuring device information acquired by the onboard distance measuring device as the sensor information, thereby calculating at least one of the position and the orientation of the moving object, and in a second case where the moving object is not equipped with the onboard distance measuring device, the calculation unit uses, as the sensor information, at least one of image information acquired by an external camera as the sensor installed in a different location from that of the moving object and external distance measuring device information acquired by an external distance measuring device as the sensor installed in a different location from that of the moving object, thereby calculating at least one of the position and the orientation of the moving object. According to this aspect, in the first case, it is possible to calculate at least one of the position and the orientation of the moving object using the onboard distance measuring device information but not the external distance measuring device information or the image information. In this manner, in the first case, for example, it is possible to prevent calculation accuracy of the position and the orientation of the moving object from decreasing as a distance from the external camera and the external distance measuring device to the moving object increases. This enables to enhance the calculation accuracy of the position and the orientation of the moving object when the moving object is moved by unmanned driving.
(2) In the above aspect, the acquisition unit may further acquire calibration information indicating whether or not calibration of the onboard distance measuring device has been completed, and in the first case, when the calibration of the onboard distance measuring device has been completed, the calculation unit may use at least the onboard distance measuring device information as the sensor information, thereby calculating at least one of the position and the orientation of the moving object, and when the calibration of the onboard distance measuring device has not been completed, the calculation unit may use at least one of the image information and the external distance measuring device information as the sensor information, thereby calculating at least one of the position and the orientation of the moving object without using the onboard distance measuring device information as the sensor information. According to this aspect, when the calibration of the onboard distance measuring device has not been completed, it is possible to calculate at least one of the position and the orientation of the moving object using at least one of the image information and the external distance measuring device information but not the onboard distance measuring device information. This enables to more reliably prevent the decrease in calculation accuracy of the position and the orientation of the moving object.
(3) In the above aspect, in the first case, the acquisition unit may acquire, in addition to the onboard distance measuring device information, at least one of the image information and the external distance measuring device information as the sensor information; the calculation unit may calculate at least one of the position and the orientation of the moving object using the onboard distance measuring device information as the sensor information, and calculate at least one of the position and the orientation of the moving object using at least one of the image information and the external distance measuring device information as the sensor information; and the calculation unit may stop calculation of the position and the orientation of the moving object using the sensor information in at least one of cases where (i) difference between the position of the moving object calculated using the onboard distance measuring device information and the position of the moving object calculated using at least one of the image information and the external distance measuring device information is greater than or equal to a predetermined position threshold, and (ii) difference between the orientation of the moving object calculated using the onboard distance measuring device information and the orientation of the moving object calculated using at least one of the image information and the external distance measuring device information is greater than or equal to a predetermined direction threshold. According to this aspect, when there is a possibility of reduced detection accuracy of the sensor, it is possible to stop calculation of the position and the orientation of the moving object. This enables to avoid calculating the position and the orientation of the moving object based on the sensor information having the possibility of reduced detection accuracy.
(4) The above aspect may further include: a signal generation unit that generates a control signal to control operation of the moving object; and a transmission unit that transmits the control signal generated by the signal generation unit to the moving object, wherein in the first case, the acquisition unit may acquire, in addition to the onboard distance measuring device information, at least one of the image information and the external distance measuring device information as the sensor information; the calculation unit may calculate at least one of the position and the orientation of the moving object using the onboard distance measuring device information as the sensor information, and calculate at least one of the position and the orientation of the moving object using at least one of the image information and the external distance measuring device information as the sensor information; and in at least one of cases where (i) difference between the position of the moving object calculated using the onboard distance measuring device information and the position of the moving object calculated using at least one of the image information and the external distance measuring device information is greater than or equal to a predetermined position threshold, and (ii) difference between the orientation of the moving object calculated using the onboard distance measuring device information and the orientation of the moving object calculated using at least one of the image information and the external distance measuring device information is greater than or equal to a predetermined direction threshold, the signal generation unit may generate, as the control signal, any one of (a) a stop control signal to stop the moving object, and (b) a change control signal to change a destination to which the moving object runs by remote control from the outside, from a predetermined target location to a maintenance site where at least one of a repair process to repair the onboard distance measuring device and a calibration process to calibrate the onboard distance measuring device is performed. According to this aspect, when there is a possibility of reduced detection accuracy of the sensor, it is possible to stop the moving object more safely, or perform maintenance of the onboard distance measuring device.
(5) The above aspect may further include a notification control unit that notifies a user of specific information indicating that there is a possibility of reduced detection accuracy of the sensor, wherein in the first case, the acquisition unit may acquire, in addition to the onboard distance measuring device information, at least one of the image information and the external distance measuring device information as the sensor information; the calculation unit may calculate at least one of the position and the orientation of the moving object using the onboard distance measuring device information as the sensor information, and calculate at least one of the position and the orientation of the moving object using at least one of the image information and the external distance measuring device information as the sensor information; and the notification control unit may notify the user of the specific information in at least one of cases where (i) difference between the position of the moving object calculated using the onboard distance measuring device information and the position of the moving object calculated using at least one of the image information and the external distance measuring device information is greater than or equal to a predetermined position threshold, and (ii) difference between the orientation of the moving object calculated using the onboard distance measuring device information and the orientation of the moving object calculated using at least one of the image information and the external distance measuring device information is greater than or equal to a predetermined direction threshold. According to this aspect, it is possible to notify the user that there is the possibility of reduced detection accuracy of the sensor.

The present disclosure can be realized in various forms other than the calculation device described above. For example, it can be realized in forms of a method of calculating at least one of the position and the orientation of the moving object, a method of manufacturing the calculation device, a control method of the calculation device, a computer program realizing the control method, a non-transitory recording medium on which the computer program is recorded, or the like.

### BRIEF DESCRIPTION OF THE DRAWINGS

FIG. 1 is a diagram illustrating a schematic configuration of a calculation system in a first embodiment;

FIG. 2 is a flowchart illustrating a process procedure of running control of a vehicle in the first embodiment;

FIG. 3 is a flowchart illustrating a calculation method and an operation control method in the first embodiment;

FIG. 4 is a diagram illustrating a calculation method of a position and orientation of a vehicle using in-vehicle LiDAR information;

FIG. 5 is a diagram illustrating a calculation method of orientation of a vehicle using external LiDAR information;

FIG. 6 is a flowchart illustrating a calculation method in a second embodiment;

FIG. 7 is a flowchart illustrating an operation control method in the second embodiment;

FIG. 8 is a diagram illustrating a schematic configuration of a calculation system in a third embodiment; and

FIG. 9 is a flowchart illustrating a process procedure of running control of a vehicle in the third embodiment.

### DETAILED DESCRIPTION

### A. First Embodiment

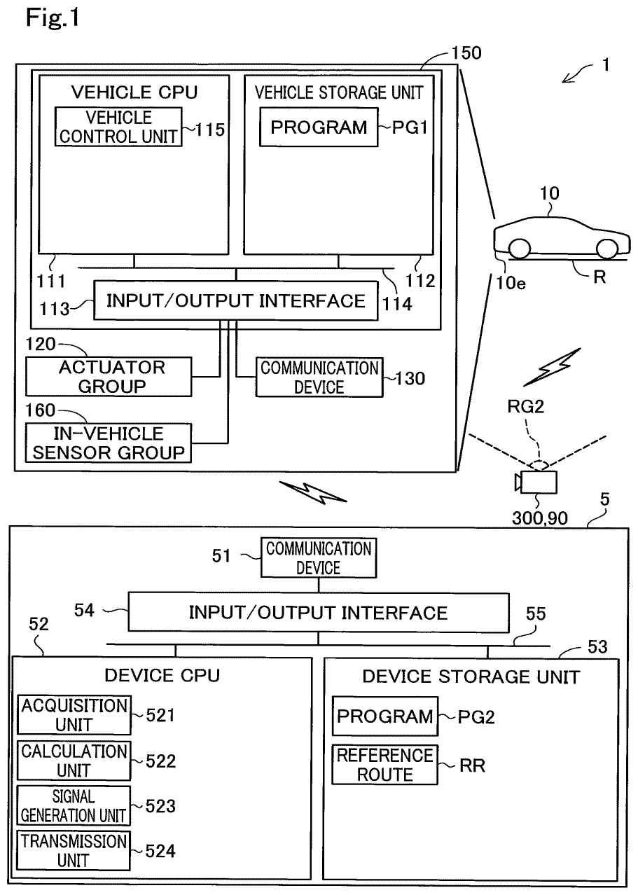

FIG. 1 is a diagram illustrating a schematic configuration of a calculation system 1 in a first embodiment. The calculation system 1 calculates at least one of a position and orientation of a moving object. The calculation system 1 includes one or more vehicles 10 as the moving object, one or more types of external sensors 300 installed in a different location from that of the vehicle 10, and a calculation device 5.

The one or more types of external sensors 300 installed in the different location from that of the vehicle 10 acquire overhead view information indicating the vehicle 10 and a state of a surrounding area of the vehicle 10. The external sensor 300 is located outside the vehicle 10. In the present embodiment, the calculation system 1 includes one or more external LiDARs 90 as the external sensor 300 to acquire the overhead view information. The external LiDAR 90 is one example of an external distance measuring device, which is a distance measuring device installed in a different location from that of the vehicle 10. Note that in the other embodiments, the distance measuring device may be other sensors such as a stereo camera.

The external LiDAR 90 is a LIDAR (LIDAR: Light Detection And Ranging) that detects the vehicle 10 from the outside thereof. The external LiDAR 90 irradiates a predetermined detection range RG2 with a laser beam and detects light reflected by an object such as the vehicle 10, thereby detecting a distance and an angle between the external LiDAR 90 and the object, shape of the object, and the like. The external LIDAR 90 transmits external LiDAR information thus acquired to the calculation device 5. The installation position and number of the external LiDAR 90 are determined in consideration of the detection range RG2 of each external LiDAR 90, an object (obstacle) present in a surrounding area of the track R, and the like to detect an entire track R by one or more external LiDARs 90. Note that the configuration of the external LIDAR 90 is not limited to the above.

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a track, a bus, a two-wheel vehicle, a four-wheel vehicle, a construction vehicle, or a combat vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The vehicle 10 is configured to be capable of running by unmanned driving. The “unmanned driving” means driving independent of running operation by a passenger. The running operation means operation relating to at least one of “run,” “turn,” and “stop” of the vehicle 10. The unmanned driving is realized by automatic remote control or manual remote control using a device provided outside the vehicle 10 or by autonomous control by the vehicle 10. A passenger not involved in running operation may be on-board a vehicle running by the unmanned driving. The passenger not involved in running operation includes a person simply sitting in a seat of the vehicle 10 and a person doing work such as assembly, inspection, or operation of switches different from running operation while on-board the vehicle 10. Driving by running operation by a passenger may also be called “manned driving.”

In the present specification, the “remote control” includes “complete remote control” by which all motions of the vehicle 10 are completely determined from outside the vehicle 10, and “partial remote control” by which some of the motions of the vehicle 10 are determined from outside the vehicle 10. The “autonomous control” includes “complete autonomous control” by which the vehicle 10 controls a motion of the vehicle 10 autonomously without receiving any information from a device outside the vehicle 10, and “partial autonomous control” by which the vehicle 10 controls a motion of the vehicle 10 autonomously using information received from a device outside the vehicle 10.

In the present embodiment, the calculation system 1 is used in a factory where the vehicle 10 is produced. A reference coordinate system for the factory is a global coordinate system. That is, a given position in the factory is represented by X, Y, and Z coordinates in the global coordinate system. Note that in the other embodiments, the calculation system 1 may be used in a location other than the factory.

The vehicle 10 has an actuator group 120. The actuator group 120 includes an actuator of a driving device to accelerate the vehicle 10, an actuator of a steering device to change a traveling direction of the vehicle 10, and an actuator of a braking device to decelerate the vehicle 10. The vehicle 10 further includes: a communication device 130 to communicate with other devices (for example, calculation device 5) except the own vehicle 10, as well as the other vehicles 10 using wireless communication or the like; a vehicle control device 150 which controls operation of the vehicle 10; and an in-vehicle sensor group 160 having one or more types of internal sensors.

The vehicle control device 150 includes a vehicle CPU 111, a vehicle storage unit 112, an input/output interface 113, and an internal bus 114. The input/output interface 113 is used to communicate with various devices (for example, a driving device) mounted on the own vehicle 10, the in-vehicle sensor group 160, and the like. The vehicle CPU 111, the vehicle storage unit 112, and the input/output interface 113 are connected through the internal bus 114 such that they can bidirectionally communicate with each other. The vehicle CPU 111 executes a program PG1 stored in the vehicle storage unit 112, thereby realizing various functions including a function of a vehicle control unit 115.

The vehicle control unit 115 controls the actuator group 120 to run the vehicle 10. The vehicle control unit 115 can control the actuator group 120 using a running control signal received from the calculation device 5, thereby running the vehicle 10. The running control signal is a control gingal to run the vehicle 10. In the present embodiment, the running control signal includes acceleration and a steering angle of the vehicle 10 as parameters. In the other embodiments, the running control signal may include a speed of the vehicle 10 as a parameter, instead of or in addition to the acceleration of the vehicle 10.

The in-vehicle sensor group 160 includes, for example, an in-vehicle camera, an in-vehicle radar, and an in-vehicle LiDAR (LIDAR: Light Detection And Ranging) as a sensor which acquires surroundings information indicating the state of the surrounding area of the vehicle 10. The in-vehicle camera captures the state of the surrounding area of the vehicle 10. The in-vehicle radar and the in-vehicle LiDAR detect an object present in the surrounding area of the vehicle 10. The in-vehicle LIDAR is one example of an onboard distance measuring device, which is a distance measuring device mounted on the vehicle 10. Note that the configuration of the vehicle 10 is not limited to the above.

The calculation device 5 calculates at least one of a position and orientation of the vehicle 10 using sensor information. In the present embodiment, the calculation device 5 is a server installed in a different location from that of the vehicle 10. In the present embodiment, the calculation device 5 calculates the position and the orientation of the vehicle 10. Additionally, the calculation device 5 uses the calculated position and orientation of the vehicle 10 to generate the running control signal to specify running operation of the vehicle 10, and transmits the running control signal to the vehicle 10. The sensor information is acquired by a sensor for acquiring at least one of the overhead view information and the surroundings information. Accordingly, the sensor information is, for example, at least one of in-vehicle LiDAR information, which is onboard distance measuring device information acquired by the in-vehicle LiDAR as an onboard distance measuring device, and the external LiDAR information, which is external distance measuring device information acquired by the external LIDAR 90 as an external distance measuring device. The position of the vehicle 10 corresponds to a position of a positioning point 10e preset to a specific part of the vehicle 10. The position of the positioning point 10e is represented by coordinate values in the global coordinate system. The orientation of the vehicle 10 corresponds to a direction represented by a vector directed from a rear side Re to a front side Fr of the vehicle 10 along a longitudinal axis of the vehicle 10 passing through a center of gravity of the vehicle 10.

The calculation device 5 includes a communication device 51, a device storage unit 53, a device CPU 52, an input/output interface 54, and an internal bus 55. The device CPU 52, the device storage unit 53, and the input/output interface 54 are connected through the internal bus 55 such that they can bidirectionally communicate with each other. The input/output interface 54 is connected with the communication device 51 to communicate with various devices external to the calculation device 5. The communication device 51 can communicate with the communication device 130 mounted on the vehicle 10, the external LiDAR 90, and the like. The communication device 51 is, for example, a wireless communication device. The device storage unit 53 stores various information including various programs PG2 for controlling operation of the calculation device 5. The device storage unit 53 includes, for example, RAM, ROM, and a hard disk drive (HDD). The device CPU 52 develops the various programs PG2 stored in the device storage unit 53, thereby realizing various functions including functions of an acquisition unit 521, a calculation unit 522, a signal generation unit 523, and a transmission unit 524.

The acquisition unit 521 acquires various information. In the present embodiment, the acquisition unit 521 acquires various information including equipment information and the sensor information. The equipment information is information indicating whether or not the in-vehicle LiDAR is mounted on the vehicle 10 as a target vehicle whose position and orientation is to be calculated. For example, the acquisition unit 521 refers to an equipment database previously stored in the device storage unit 53, thereby acquiring the equipment information regarding the vehicle 10 as the target vehicle. By referring to the equipment database in which vehicle identification information for identifying the vehicle 10 is associated with whether or not the in-vehicle LiDAR is mounted, the equipment information regarding the vehicle 10 whose position and orientation are to be calculated is acquired. Note that the method of acquiring the equipment information is not limited to the above. For example, the acquisition unit 521 may acquire communicability information as the equipment information from the vehicle control device 150, the communicability information indicating whether or not the in-vehicle LiDAR mounted on the vehicle 10, which is the target vehicle whose position and orientation are to be calculated, can communicate with the vehicle control device 150. Additionally, when the in-vehicle LiDAR is attached to the outside of the vehicle 10, the acquisition unit 521 may acquire, as the equipment information, a detection result indicating whether or not the in-vehicle LiDAR attached to the vehicle 10 can be detected in image information which is a captured image including the vehicle 10.

The calculation unit 522 calculates at least one of the position and the orientation of the vehicle 10 using the sensor information acquired by the acquisition unit 521. In the present embodiment, the calculation unit 522 calculates the position and the orientation of the vehicle 10 using the sensor information, thereby acquiring vehicle position information. The vehicle position information is position information that is a basis for generating the running control signal. In the present embodiment, the vehicle position information includes the position and the orientation of the vehicle 10 in the global coordinate system for the factory.

The signal generation unit 523 generates the running control signal to specify the running operation of the vehicle 10 to control the vehicle 10. The signal generation unit 523 generates, for example, a standard control signal which is the running control signal to run the vehicle 10 along a predetermined reference route RR. Additionally, the signal generation unit 523 may generate, for example, the running control signals below according to accuracy of the position and the orientation of the vehicle 10 calculated by the calculation unit 522 and running status of the vehicle 10, etc. In this case, the signal generation unit 523 may generate a stop control signal which is the running control signal to stop the vehicle 10, or a change control signal which is the running control signal to change a destination of the vehicle 10.

The transmission unit 524 transmits various information. In the present embodiment, the transmission unit 524 transmits the running control signal generated by the signal generation unit 523 to the vehicle 10. Note that the configuration of the device CPU 52 is not limited to the above. At least some of the functions of the device CPU 52 may be realized as one function of the other devices (for example, external LIDAR 90, in-vehicle LiDAR, vehicle control device 150).

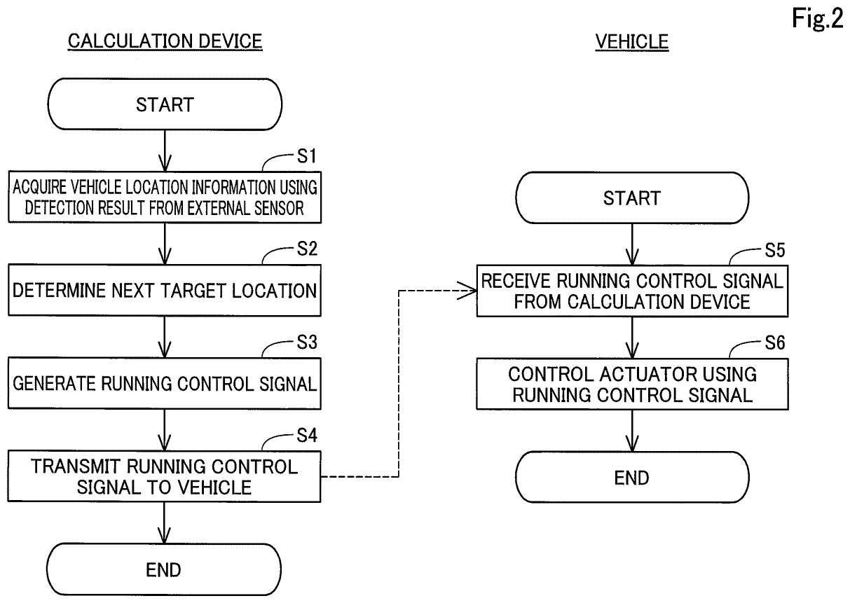

FIG. 2 is a flowchart illustrating a process procedure of running control of the vehicle 10 in the first embodiment. For example, the flow shown in FIG. 2 is repeatedly executed at predetermined time intervals from the time when the vehicle 10 starts running by remote control.

In step 1, the calculation unit 522 of the calculation device 5 acquires the vehicle position information using the sensor information.

In step 2, the signal generation unit 523 determines a target location to which the vehicle 10 is to move next. In the present embodiment, the target location is expressed by X, Y, and Z coordinates in the global coordinate system. The device storage unit 53 contains a reference route RR stored in advance as a route along which the vehicle 10 is to run. The route is expressed by a node indicating a departure place, a node indicating a way point, a node indicating a destination, and a link connecting nodes to each other. The signal generation unit 523 determines the target location to which the vehicle 10 is to move next using the vehicle location information and the reference route RR. The signal generation unit 523 determines the target location on the reference route RR ahead of a current location of the vehicle 10.

In step 3, the signal generation unit 523 generates a running control signal for causing the vehicle 10 to run toward the determined target location. In the present embodiment, the running control signal includes an acceleration and a steering angle of the vehicle 10 as parameters. The signal generation unit 523 calculates a running speed of the vehicle 10 from transition of the location of the vehicle 10 and makes comparison between the calculated running speed and a target speed of the vehicle 10 determined in advance. If the running speed is lower than the target speed, the signal generation unit 523 generally determines an acceleration in such a manner as to accelerate the vehicle 10. If the running speed is higher than the target speed as, the signal generation unit 523 generally determines an acceleration in such a manner as to decelerate the vehicle 10. If the vehicle 10 is on the reference route RR, signal generation unit 523 determines a steering angle and an acceleration in such a manner as to prevent the vehicle 10 from deviating from the reference route RR. If the vehicle 10 is not on the reference route RR, in other words, if the vehicle 10 deviates from the reference route RR, the signal generation unit 523 determines a steering angle and an acceleration in such a manner as to return the vehicle 10 to the reference route RR.

In step 4, the transmission unit 524 transmits the generated running control signal to the vehicle 10. The calculation device 5 repeats the acquisition of vehicle location information, the determination of a target location, the generation of a running control signal, the transmission of the running control signal, and others in a predetermined cycle.

In step 5, the vehicle control unit 115 of the vehicle control device 150 mounted on the vehicle 10 receives the running control signal transmitted from the calculation device 5. In step 6, the vehicle 10 controls an actuator of the vehicle 10 using the received running control signal, thereby causing the vehicle 10 to run at the acceleration and the steering angle indicated by the running control signal. The vehicle control device 150 repeats the reception of a running control signal and the control over the actuator group 120 in a predetermined cycle. According to the calculation system 1 in the present embodiment, it becomes possible to move the vehicle 10 without using a transport unit such as a crane or a conveyor.

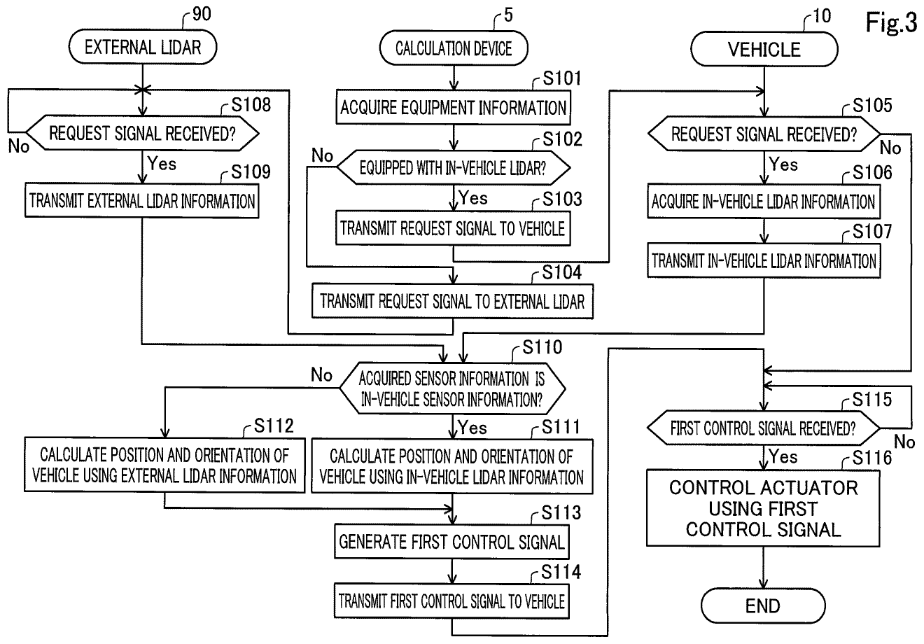

FIG. 3 is a flowchart illustrating a calculation method and an operation control method in the first embodiment. The calculation method is a method of calculating the position and the orientation of the vehicle 10. The operation control method is a method of controlling the running operation of the vehicle 10 by using the position and the orientation of the vehicle 10 calculated by performing the calculation method to generate and transmit the running control signal. The flowchart shown in FIG. 3 is executed, for example, when powers of the calculation device 5, the external LiDAR 90, and the vehicle 10 are turned on.

In step 101, the acquisition unit 521 of the calculation device 5 acquires the equipment information. In a first case where the vehicle 10 is equipped with the in-vehicle LiDAR (step 102: Yes), the transmission unit 524 transmits, to the vehicle 10, a request signal to request the sensor information in step 103. On the other hand, in a second case where the vehicle 10 is not equipped with the in-vehicle LiDAR (step 102: No), the transmission unit 524 transmits the request signal to the external LiDAR 90 in step 104.

When the vehicle control device 150 of the vehicle 10 receives the request signal (step 105: Yes), the vehicle control device 150 acquires the in-vehicle LiDAR information from the in-vehicle LiDAR in step 106. Then, in step 107, the vehicle control device 150 transmits the in-vehicle LiDAR information to the calculation device 5. In this manner, the acquisition unit 521 of the calculation device 5 acquires the in-vehicle LiDAR information as the sensor information in the case where the vehicle 10 is equipped with the in-vehicle LiDAR.

When the external LiDAR 90 receives the request signal (step 108: Yes), the external LiDAR 90 transmits the external LiDAR information to the calculation device 5 in step 109. In this manner, the acquisition unit 521 of the calculation device 5 acquires the external LiDAR information as the sensor information in the case where the vehicle 10 is not equipped with the in-vehicle LiDAR.

When the sensor information acquired by the acquisition unit 521 is in-vehicle sensor information (step 110: Yes), the calculation unit 522 calculates the position and the orientation of the vehicle 10 using the in-vehicle LiDAR information, thereby acquiring the vehicle position information in step 111.

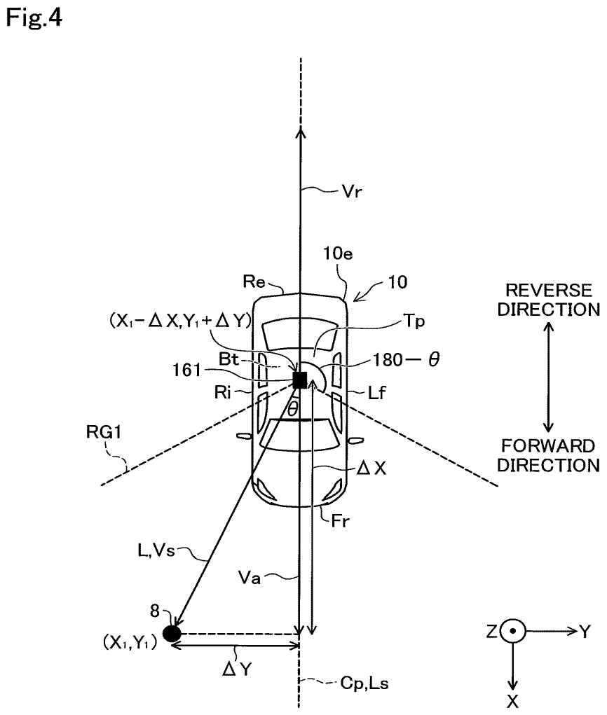

FIG. 4 is a diagram illustrating one example of the calculation method of the position and the orientation of the vehicle 10 using the in-vehicle LiDAR information. In the present disclosure, an X direction along an X-axis is a longitudinal (full length) direction of the vehicle 10, a +X direction side is the front side Fr of the vehicle 10, and a −X direction side is the rear side Re of the vehicle 10. Therefore, a forward direction of the vehicle 10 corresponds to the +X direction and a reverse direction of the vehicle 10 corresponds to the −X direction. Further, a Y direction along a Y-axis is a left and right (vehicle width) direction of the vehicle 10, a +Y direction side is a left side Lf of the vehicle 10, and a −Y direction side is a right side Ri of the vehicle 10. Yet further, a Z direction along a Z-axis is a vertical (vehicle height) direction of the vehicle 10, a +Z direction side is a top side Tp (ceiling side) of the vehicle 10, and a −Z direction side is a bottom side Bt (floor side).

In the example shown in FIG. 4, a reference object 8 that can reflect a laser beam emitted by an in-vehicle LiDAR 161 is illustrated. A plurality of reference objects 8 may be arranged at different positions. Coordinate values (absolute position) of one or more reference objects 8 in the global coordinate system are known. The calculation unit 522 detects one or more reference objects 8 that can reflect a laser beam by the in-vehicle LiDAR 161 to calculate a detection vector Vs, thereby calculating the position and the orientation of the vehicle 10. The detection vector Vs is a vector directed from the in-vehicle LiDAR 161 to the reference object 8. The detection vector Vs has a distance L between the in-vehicle LiDAR 161 and the reference object 8, and orientation from the in-vehicle LiDAR 161 to the reference object 8. The orientation from the in-vehicle LiDAR 161 to the reference object 8 is represented by an angle e made by a reference optical axis Ls with the detection vector Vs. The reference optical axis Ls corresponds to a center line of a detection range RG1 which is an irradiation range of the laser beam irradiated from a projector of the in-vehicle LiDAR 161. The reference object 8 is, for example, a pole (prop) to which a reflector reflecting the laser beam is attached. Information regarding the absolute position of the reference object 8 and information regarding the in-vehicle LiDAR 161 are previously stored in the device storage unit 53, for example. The information regarding the in-vehicle LiDAR 161 is, for example, an installation position of the in-vehicle LiDAR 161 on the vehicle 10, relative positional relation between the in-vehicle LiDAR 161 and the positioning point 10e of the vehicle 10, and angular difference between a longitudinal axis Cp of the vehicle 10 and the reference optical axis Ls of the in-vehicle LiDAR 161. In the present embodiment, the in-vehicle LiDAR 161 is installed on the vehicle 10 such that the reference optical axis Ls of the in-vehicle LiDAR 161 is aligned with the X-axis that is the longitudinal axis Cp of the vehicle 10. In other words, the angular difference between the longitudinal axis Cp of the vehicle 10 and the reference optical axis Ls of the in-vehicle LiDAR 161 is zero.

The in-vehicle LiDAR 161 emits a laser beam from the projector and measures the time until an optical receiver receives light reflected by the reflector attached to the reference object 8, thereby acquiring the distance L from the installation position of the in-vehicle LiDAR 161 to the reference object 8. Further, the in-vehicle LiDAR 161 acquires an emission angle θ of the laser beam relative to the reference optical axis Ls of the in-vehicle LiDAR 161 as the orientation from the in-vehicle LiDAR 161 to the reference object 8. Then, the distance L and the angular difference θ between the reference optical axis Ls and the detection vector Vs acquired by the in-vehicle LiDAR 161 are transmitted as the in-vehicle LiDAR information to the calculation device 5, and thus the acquisition unit 521 of the calculation device 5 acquires the in-vehicle LIDAR information.

The calculation unit 522 acquires the most recent running control signal transmitted to the vehicle 10 by the transmission unit 524 to calculate the orientation of the vehicle 10. Then, the calculation unit 522 determines whether the vehicle 10 is running in the forward direction or the reverse direction. Next, when it is determined that the vehicle 10 is running in the forward direction, for example, the calculation unit 522 uses the in-vehicle LiDAR 161 as a rotation center and rotates the detection vector Vs in a first prescribed direction by the angular difference θbetween the reference optical axis Ls of the in-vehicle LiDAR 161 and the detection vector Vs. In the example shown in FIG. 4, the first prescribed direction is a counterclockwise direction. When it is determined that the vehicle 10 is running in the forward direction, the direction in which a forward vector Va obtained after this rotation is directed is the orientation of the vehicle 10 and is a travelling direction of the vehicle 10. On the other hand, when it is determined that the vehicle 10 is running in the reverse direction, for example, the calculation unit 522 uses the in-vehicle LiDAR 161 as a rotation center and rotates the detection vector Vs in a second prescribed direction by an angle (180°-θ) obtained by subtracting the angular difference θ between the reference optical axis Ls of the in-vehicle LiDAR 161 and the detection vector Vs from 180°. In the example shown in FIG. 4, the second prescribed direction is a clockwise direction. When it is determined that the vehicle 10 is running in the reverse direction, a direction in which a reverse vector Vr obtained after this rotation is directed is the traveling direction of the vehicle 10, and the forward vector Va is the orientation of the vehicle 10.

Note that the calculation unit 522 may compare the angular difference e between the reference optical axis Ls of the in-vehicle LiDAR 161 and the detection vector Vs acquired at different time points, for example, thereby determining whether the vehicle 10 is running in the forward direction or the reverse direction. Specifically, when the angular difference e between the reference optical axis Ls and the detection vector Vs at a first time point is smaller than the angular difference θ between the reference optical axis Ls and the detection vector Vs at a second time point, the calculation unit 522 determines that the vehicle 10 is running in the forward direction. The second time point is a point later than the first time point. On the other hand, when the angular difference θ between the reference optical axis Ls and the detection vector Vs at the first time point is greater than the angular difference θ between the reference optical axis Ls and the detection vector Vs at the second time point, the calculation unit 522 determines that the vehicle 10 is moving in reverse.

To calculate the position of the vehicle 10, the calculation unit 522 calculates coordinate values indicating the position of the in-vehicle LiDAR 161 in the global coordinate system using the in-vehicle LiDAR information. Specifically, the calculation unit 522 executes the following process using the absolute position of the reference object 8, the distance L from the installation position of the in-vehicle LiDAR 161 to the reference object 8, and the angular difference θ between the reference optical axis Ls of the in-vehicle LiDAR 161 and the detection vector Vs. In this case, the calculation unit 522 calculates, using a trigonometric function, difference ΔX between the coordinate values of the in-vehicle LiDAR 161 and the specific reference object 8 in the X direction, and difference ΔY between the coordinate values of the in-vehicle LIDAR 161 and the specific reference object 8 in the Y direction, the specific reference object 8 being the single specific reference object 8. Then, the calculation unit 522 reflects the difference ΔX in the X direction and the difference ΔY in the Y direction in the coordinate values indicating the absolute position of the specific reference object 8, respectively, while considering the angular difference θ between the reference optical axis Ls of the in-vehicle LiDAR 161 and the detection vector Vs. In this manner, the calculation unit 522 calculates the coordinate values of the in-vehicle LiDAR 161 in the global coordinate system. Next, the calculation unit 522 calculates the coordinate values of the positioning point 10e of the vehicle 10 in the global coordinate system from the calculated coordinate values of the in-vehicle LiDAR 161 in the global coordinate system, based on the relative positional relation between the in-vehicle LIDAR 161 and the positioning point 10e of the vehicle 10. Then, the calculation unit 522 employs the coordinate values of the positioning point 10e of the vehicle 10 in the global coordinate system as the position of the vehicle 10.

Note that the above method shown in FIG. 4 may be applied to a case where the external LiDAR information is used to calculate the position and the orientation of the vehicle 10. In this case, the calculation unit 522 may use information regarding a distance and an angle included in the external LiDAR information to calculate the position and the orientation of the vehicle 10. The external LiDAR information is information acquired by detecting the specific reference object 8 and the vehicle 10 by the external LiDAR 90. When the position of the vehicle 10 is to be calculated, the calculation unit 522 uses a distance between the external LiDAR 90 and the specific reference object 8 as well as angular difference between a reference optical axis of the external LiDAR 90 and a detection vector directed from the external LiDAR 90 to the reference object 8 to calculate coordinate values in the global coordinate system which indicate more accurate position of the external LiDAR 90. Thereafter, the calculation unit 522 uses a distance between the external LiDAR 90 and the vehicle 10 as well as angular difference between the reference optical axis of the external LiDAR 90 and a detection vector directed from the external LiDAR 90 to the vehicle 10 to calculate the coordinate values indicating the position of the vehicle 10 in the global coordinate system. In this manner, the calculation unit 522 can calculate the position of the vehicle 10 based on the more accurate absolute position of the external LiDAR 90. Note that when the external LiDAR information is used to calculate the position and the orientation of the vehicle 10, it is not essential to use the information regarding the reference object 8.

As shown in FIG. 3, when the sensor information acquired by the acquisition unit 521 is the external LiDAR information (step 110: No), the calculation unit 522 calculates the position and the orientation of the vehicle 10 using the external LiDAR information, thereby acquiring the vehicle position information in step 112.

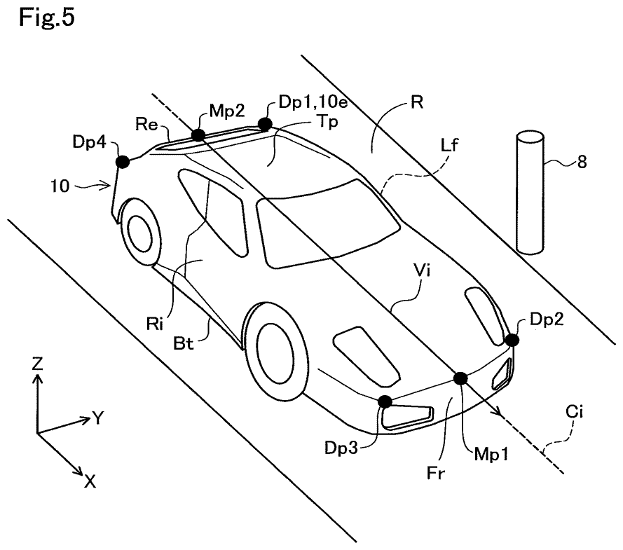

FIG. 5 is a diagram illustrating one example of the calculation method of the orientation of the vehicle 10 using the external LiDAR information. In the example shown in FIG. 5, the calculation unit 522 calculates the orientation of the vehicle 10 using coordinate values indicating positions of a plurality of detection points Dp1 to Dp4 of the vehicle 10 detected from three-dimensional point cloud information included in the external LiDAR information. In FIG. 5, the plurality of detection points Dp1 to Dp4 of the vehicle 10 includes a first detection point Dp1 located at a left rear end of the vehicle 10, a second detection point Dp2 located at a left front end of the vehicle 10, a third detection point Dp3 located at a right front end of the vehicle 10, and a fourth detection point Dp4 located at a right rear end of the vehicle 10. Hereinafter, the calculation method using the aforementioned detection points Dp1 to Dp4 located at four corners of the vehicle 10 will be described.

First, the external LiDAR 90 acquires relative positional relation between the plurality of detection points Dp1 to Dp4 of the vehicle 10 and the specific reference object 8, and transmits it as infrastructure sensor information to the calculation device 5. Next, the calculation unit 522 calculates coordinate values of the respective detection points Dp1 to Dp4 in the global coordinate system using the absolute position of the specific reference object 8 and the infrastructure sensor information acquired by the acquisition unit 521. Next, the calculation unit 522 calculates middle points Mp1, Mp2 on the front side Fr and the rear side Re of the vehicle 10, respectively. Specifically, the calculation unit 522 calculates the first middle point Mp1 having coordinate values of an intermediate position between the second detection point Dp2 and the third detection point Dp3, and the second middle point Mp2 having coordinate values of an intermediate position between the first detection point Dp1 and the fourth detection point Dp4. When calculating each of the middle points Mp1, Mp2, the calculation unit 522 may calculate the coordinate values at least in the X and Y directions. Next, the calculation unit 522 calculates an intermediate axis Ci connecting the first middle point Mp1 and the second middle point Mp2. Next, the calculation unit 522 calculates an intermediate vector Vi, which is a vector along the intermediate axis Ci, based on the determination result of whether the vehicle 10 is running in the forward direction or the reverse direction. A direction in which this intermediate vector Vi is directed is the traveling direction of the vehicle 10. The calculation unit 522 determines whether the vehicle 10 is running in the forward direction or the reverse direction based on the most recent running control signal transmitted to the vehicle 10 by the transmission unit 524. Then, the calculation unit 522 calculates the orientation of the vehicle 10 based on the traveling direction of the vehicle 10 and the direction in which the intermediate vector Vi is directed.

Note that the number of the plurality of detection points Dp1 to Dp4 and the positions thereof in the vehicle 10 are not limited to the above. The number of a plurality of detection points may be two, where one of the detection points may be an antenna attached to the ceiling of the vehicle 10, and the other detection point may be an emblem attached to a front grille or the like on the front side Fr of the vehicle 10, for example. In this case, the calculation unit 522 calculates the orientation of the vehicle 10 using the coordinate values of the two detection points in the global coordinate system, as well as the installation positions of the antenna and the emblem on the vehicle 10, that is, relative positional relation of the antenna and the emblem to the longitudinal axis of the vehicle 10.

As shown in FIG. 3, in step 113, the signal generation unit 523 of the calculation device 5 executes the following process using the vehicle position information and the reference route RR. In this case, the signal generation unit 523 determines a target location where the vehicle 10 is supposed to go next, and generates a first control signal to run the vehicle 10 towards the determined target location. The first control signal is, for example, a standard control signal. Then, in step 114, the transmission unit 524 transmits the first control signal to the vehicle 10. When the vehicle control device 150 receives the first control signal (step 115: Yes), the vehicle control device 150 controls the actuator group 120 using the received first control signal in step 116.

According to the above first embodiment, in the case where the vehicle 10 is equipped with the in-vehicle LiDAR 161, it is possible to calculate the position and the orientation of the vehicle 10 using the in-vehicle LiDAR information acquired by the in-vehicle LiDAR 161. In a case of using a sensor provided in a different location from that of the vehicle 10, such as the external LiDAR 90, proportion of the vehicle 10 in the detection range RG2 decreases as the distance between the vehicle 10 and the sensor increases. Accordingly, there is a risk that calculation accuracy of the position and the orientation of the vehicle 10 decreases. On the other hand, according to the above first embodiment, in the case where the vehicle 10 is equipped with the in-vehicle LiDAR 161, it is possible to calculate the position and the orientation of the vehicle 10 without using the sensor information acquired by the sensor installed in the different location from that of the vehicle 10. Accordingly, in the case where the vehicle 10 is equipped with the in-vehicle LiDAR 161, it is possible to prevent the decrease in the calculation accuracy of the position and the orientation of the vehicle 10.

Further, according to the above first embodiment, in the case where the vehicle 10 is not equipped with the in-vehicle LiDAR 161, it is possible to calculate the position and the orientation of the vehicle 10 using the external LiDAR information. For example, when the image information including the vehicle 10 is analyzed to calculate the position and the orientation of the vehicle 10, the calculation accuracy of the position and the orientation of the vehicle 10 may decrease due to difference in imaging conditions such as weather, a season, a period of time, and a location at the time of imaging. On the other hand, according to the above first embodiment, it is possible to calculate the position and the orientation of the vehicle 10 without using the image information. Accordingly, in the case where the vehicle 10 is not equipped with the in-vehicle LiDAR 161, it is possible to prevent the decrease in the calculation accuracy of the position and the orientation of the vehicle 10.

Furthermore, according to the above first embodiment, in a case where the vehicle 10 is run by unmanned driving, it is possible to generate the running control signal using the calculated position and orientation of the vehicle 10, thereby controlling the running operation of the vehicle 10.

### B. Second Embodiment

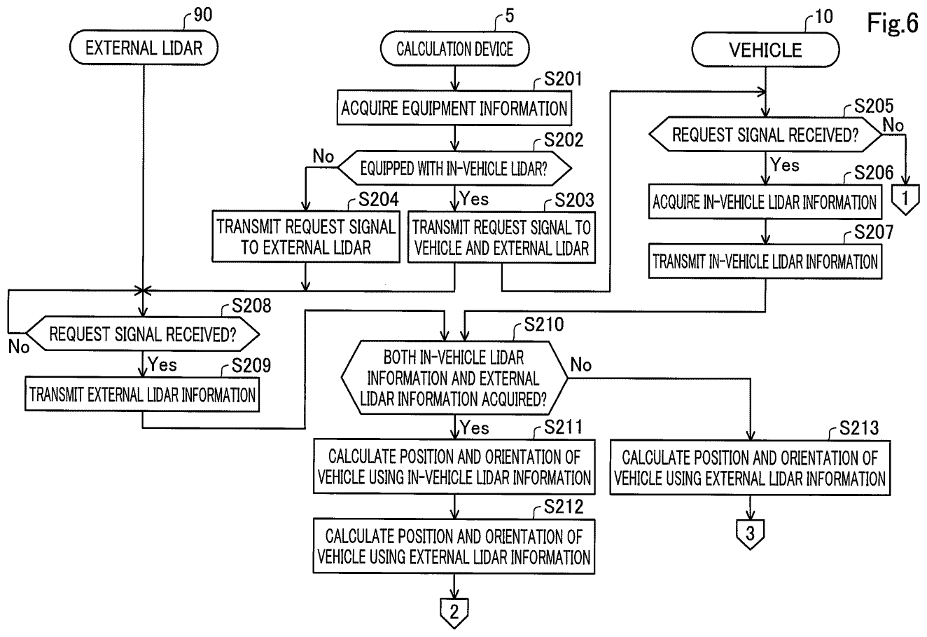

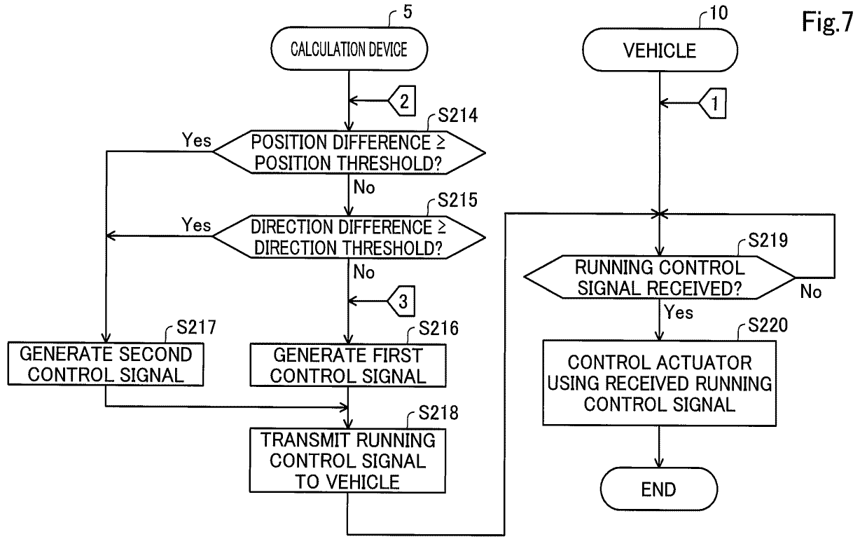

FIG. 6 is a flowchart illustrating a calculation method in a second embodiment. FIG. 7 is a flowchart illustrating an operation control method in the second embodiment. In the present embodiment, a method of generating a different running control signal according to detection accuracy of the sensor for acquiring the sensor information will be described.

As shown in FIG. 6, in step 201, the acquisition unit 521 of the calculation device 5 acquires the equipment information. In the first case where the vehicle 10 is equipped with the in-vehicle LiDAR 161 (step 202: Yes), the transmission unit 524 transmits the request signal to the vehicle 10 and the external LiDAR 90 in step 203. On the other hand, in the second case where the vehicle 10 is not equipped with the in-vehicle LiDAR 161 (step 202: No), the transmission unit 524 transmits the request signal to the external LiDAR 90 in step 204.

When the vehicle control device 150 of the vehicle 10 receives the request signal (step 205: Yes), the vehicle control device 150 acquires the in-vehicle LiDAR information from the in-vehicle LiDAR 161 in step 206. Then, in step 207, the in-vehicle LIDAR information is transmitted to the calculation device 5. When the external LiDAR 90 receives the request signal (step 208: Yes), the external LiDAR 90 transmits the external LiDAR information to the calculation device 5 in step 209.

In the case where the vehicle 10 is equipped with the in-vehicle LiDAR 161, in other words, when the acquisition unit 521 acquires both the in-vehicle LiDAR information and the external LiDAR information (step 210: Yes), the calculation unit 522 executes steps 211 and 212. In step 211, the calculation unit 522 calculates the position and the orientation of the vehicle 10 using the in-vehicle LiDAR information, thereby acquiring the vehicle position information. Further, in step 212, the calculation unit 522 calculates the position and the orientation of the vehicle 10 using the external LIDAR information, thereby acquiring the vehicle position information. Either step 211 or 212 may be executed first, or both may be executed in parallel.

As shown in FIG. 7, when position difference is less than a predetermined position threshold (step 214: No), the signal generation unit 523 executes step 215. The position difference is difference between the position of the positioning point 10e of the vehicle 10 calculated using the in-vehicle LiDAR information and the position of the positioning point 10e of the vehicle 10 calculated using the external LiDAR information which corresponds to acquisition timing of the in-vehicle LiDAR information. When direction difference is less than a predetermined direction threshold (step 215: No), the signal generation unit 523 executes step 216. In step 216, the signal generation unit 523 generates the first control signal. The direction difference is difference between the vectors Va, Vr indicative of the orientation of the vehicle 10 calculated using the in-vehicle LiDAR information and the vector Vi indicative of the orientation of the vehicle 10 calculated using the external LiDAR information which corresponds to the acquisition timing of the in-vehicle LiDAR information. In at least one of the cases where the position difference is greater than or equal to the position threshold (step 214: Yes) and where the direction difference is greater than or equal to the direction threshold (step 215: Yes), the signal generation unit 523 generates a second control signal in step 217. The second control signal is, for example, at least one running control signal of the stop control signal and the change control signal. The stop control signal is a control signal to stop the vehicle 10. The change control signal is a control signal to change the destination to which the vehicle 10 runs by remote control from the outside, from a predetermined target location to a maintenance site. The maintenance site is a site where at least one of a repair process to repair the in-vehicle LiDAR 161 and a calibration process to calibrate the in-vehicle LiDAR 161 is performed. The calibration process is, for example, to adjust an optical axis direction of the in-vehicle LiDAR 161 such that the reference optical axis Ls of the in-vehicle LIDAR 161 and the longitudinal axis of the vehicle 10 shown in FIG. 4 are aligned with each other, or to compensate so as to make the distance L and the angle difference θ acquired by the in-vehicle LiDAR 161 correct. As shown in FIG. 7, in step 218, the transmission unit 524 transmits the control signal generated by the signal generation unit 523 to the vehicle 10. When the vehicle control device 150 receives the control signal (step 219: Yes), the vehicle control device 150 controls the actuator group 120 using the received control signal in step 220.

On the other hand, as shown in FIG. 6, in the case where the vehicle 10 is not equipped with the in-vehicle LiDAR 161, in other words, when the acquisition unit 521 acquires the external LiDAR information but not the in-vehicle LiDAR information (step 210: No), the calculation unit 522 executes step 213. In step 213, the calculation unit 522 calculates the position and the orientation of the vehicle 10 using the external LiDAR information, thereby acquiring the vehicle position information. Then, as shown in FIG. 7, in step 216, the signal generation unit 523 generates the first control signal. Note that in the case where the vehicle 10 is not equipped with the in-vehicle LiDAR 161, each step after step 216 is the same as the one in the case where the vehicle 10 is equipped with the in-vehicle LiDAR 161.

According to the above second embodiment, in the case where the vehicle 10 is equipped with the in-vehicle LiDAR 161, it is possible to calculate the position difference and the direction difference by acquiring the in-vehicle LiDAR information and the external LiDAR information as the sensor information and calculating the position and the orientation of the vehicle 10 from each sensor information. Then, when at least one of the position difference and the direction difference is greater than or equal to the threshold, it is possible to generate the stop control signal, thereby stopping the vehicle 10. In this manner, it is possible to grasp a possibility of reduced detection accuracy of at least one of the in-vehicle LiDAR 161 and the external LiDAR 90 as the sensor. Thus, when at least one of the position difference and the direction difference is greater than or equal to the threshold, that is, there is the possibility of reduced detection accuracy of the sensor, it is possible to stop the vehicle 10 more safely.

Further, according to the above second embodiment, when at least one of the position difference and the direction difference is greater than or equal to the threshold, it is possible to generate the change control signal and run the vehicle 10 toward the maintenance site. In this manner, when there is the possibility of reduced detection accuracy of the in-vehicle LiDAR 161, it is possible to perform maintenance of the in-vehicle LiDAR 161. Additionally, in the maintenance site, by inspecting whether or not there is a defect such as displacement of an optical axis in the in-vehicle LiDAR 161, it is possible to estimate whether there is a defect in the in-vehicle LiDAR 161 or the external LiDAR 90.

### C. Third Embodiment

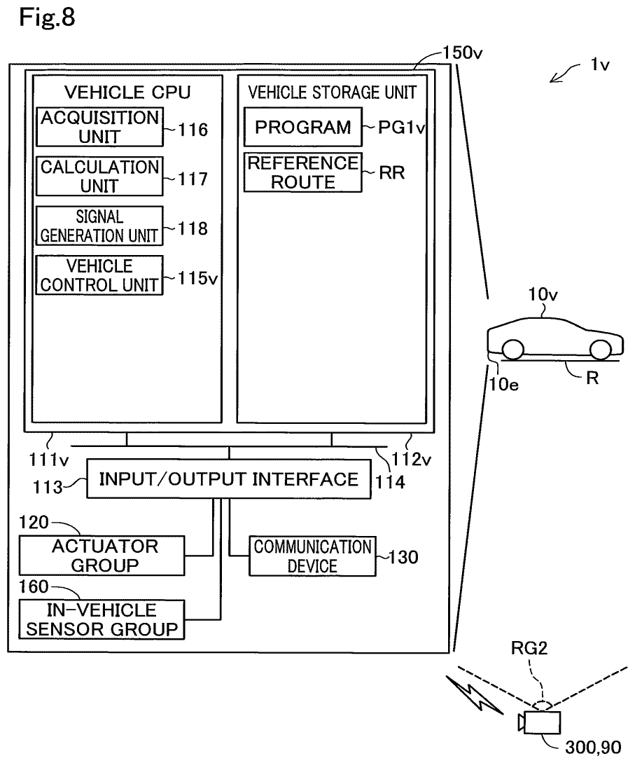

FIG. 8 is a diagram illustrating a schematic configuration of a calculation system 1v in a third embodiment. In the present embodiment, the function of the calculation device 5 is realized by a vehicle control device 150v. This enables a vehicle 10v in the present embodiment to run under autonomous control of the vehicle 10v.

A vehicle CPU 111v of the vehicle control device 150v executes a program PG1v stored in a vehicle storage unit 112v, thereby realizing various functions including functions of an acquisition unit 116, a calculation unit 117, a signal generation unit 118, and a vehicle control unit 115v.

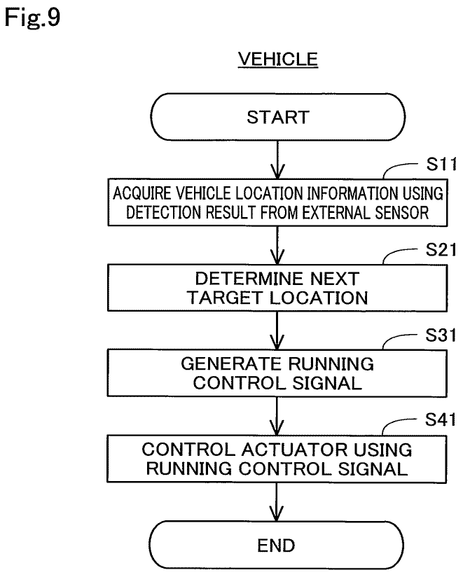

FIG. 9 is a flowchart illustrating a process procedure of running control of the vehicle 10v in the third embodiment. The flow shown in FIG. 9 is repeatedly executed, for example, at predetermined time intervals from the time when the vehicle 10v starts running under autonomous control.

In step 11, the calculation unit 117 of the vehicle control device 150v in the vehicle 10v acquires vehicle location information using sensor information. In step 21, the signal generation unit 118 determines a target location to which the vehicle 10 is to move next. In step 31, the signal generation unit 118 generates a running control signal for causing the vehicle 10v to run to the determined target location. In step 41, the vehicle control unit 115v controls the actuator group 120 using the generated running control signal, thereby causing the vehicle 10v to run by following a parameter indicated by the running control signal. The vehicle control unit 115v repeats the acquisition of vehicle location information, the determination of a target location, the generation of a running control signal, and the control over the actuator in a predetermined cycle. According to the calculation system 1v in the present embodiment, it is possible to cause the vehicle 10v to run by autonomous control without controlling the vehicle 10v remotely using the calculation device 5 installed in a different location for the vehicle 10v, such as a server.

### D. Other Embodiments

### D-1. Other Embodiment 1

The calculation system 1, 1v may include an external camera instead of or in addition to the external LiDAR 90 as the external sensor 300 installed in a different location from that of the vehicle 10, 10v to acquire the overhead view information. The external camera is an imaging device such as a CCD image sensor, which acquires a captured image as the sensor information and outputs the captured image as a detection result, the captured image being the image information including the vehicle 10, 10v. When the external sensor 300 is the external camera, the calculation unit 117, 522 acquires the vehicle position information using the captured image acquired from the external camera as the external sensor 300. In detail, for example, the calculation unit 117, 522 detects an external form of the vehicle 10, 10v from the captured image, calculates a coordinate system for the captured image, that is, coordinates of the positioning point 10e of the vehicle 10, 10v in a local coordinate system, and converts the calculated coordinates into coordinates in the global coordinate system, thereby acquiring the position of the vehicle 10, 10v. The external form of the vehicle 10, 10v included in the captured image can be detected, for example, by inputting the captured image to a detection model utilizing artificial intelligence. The detection model is, for example, prepared inside or outside the calculation system 1, 1v and stored in the storage unit 53, 112v in advance. An example of the detection model is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 10, 10v, and a label showing whether each region in the training image is a region indicating the vehicle 10, 10v or a region indicating a subject other than the vehicle 10, 10v, for example. In training the CNN, a parameter for the CNN is preferably updated through backpropagation in such a manner as to reduce error between output result obtained by the detection model and the label. The calculation unit 117, 522 can acquire the orientation of the vehicle 10 through estimation based on the direction of a motion vector of the vehicle 10 detected from change in location of a feature point of the vehicle 10, 10v between frames of the captured images using optical flow process, for example. In such embodiment, by inputting the image information to a trained machine learning model which is previously trained to detect the external form (outline) of the vehicle 10, 10v or the like in the image, it is possible to calculate the position and the orientation of the vehicle 10, 10v.

### D-2. Other Embodiment 2

In a case where the vehicle 10, 10v is equipped with the in-vehicle LiDAR 161, when calibration of the in-vehicle LiDAR 161 has not been completed, the calculation unit 117, 522 may calculate the position and the orientation of the vehicle 10, 10v using at least one of the image information and the external LiDAR information as the sensor information, but not the in-vehicle LiDAR information as the sensor information. In this case, for example, the acquisition unit 116, 521 acquires calibration information indicating whether or not the calibration of the in-vehicle LiDAR 161 has been completed. Specifically, the acquisition unit 116, 521 refers to a calibration database, for example, to acquire the calibration information regarding the in-vehicle LiDAR 161 mounted on the vehicle 10, 10v whose position and orientation are to be calculated. The calibration database is, for example, a database in which the vehicle identification information, in-vehicle LiDAR identification information for identifying the in-vehicle LIDAR 161, and calibration status of the in-vehicle LiDAR 161 are associated with each other. In this manner, the calculation device 5 selects the type of the sensor information to be used for calculating the position and the orientation of the vehicle 10, 10v based on the calibration information. When the calibration of the in-vehicle LiDAR 161 has not been completed, the acquisition unit 521 may acquire only at least one of the image information and the external LiDAR information as the sensor information but not the in-vehicle LiDAR information. Additionally, even when the calibration of the in-vehicle LiDAR 161 has not been completed, the acquisition unit 116, 521 may acquire the in-vehicle LiDAR information in addition to at least one of the image information and the external LiDAR information as the sensor information. In this case, the calculation unit 117, 522 calculates the position and the orientation of the vehicle 10 using, among the acquired sensor information, information other than the in-vehicle LiDAR information. Further, when the calibration of the in-vehicle LiDAR 161 has not been completed, the vehicle control device 150 may transmit an incomplete signal indicating that the calibration of the in-vehicle LiDAR 161 has not been completed to the calculation device 5 such as a server installed in a different location from that of the vehicle 10, 10v without acquiring the in-vehicle LiDAR information. Yet further, even when the calibration of the in-vehicle LiDAR 161 has not been completed, the vehicle control device 150, 150v may acquire the in-vehicle LiDAR information. In this case, the vehicle control device 150 may transmit the incomplete signal, instead of the acquired in-vehicle LiDAR information, to the calculation device 5 such as a server. In such embodiment, it is possible to calculate the position and the orientation of the vehicle 10, 10v using the in-vehicle LiDAR information acquired by the in-vehicle LiDAR 161 for which the calibration has been completed. This can more reliably prevent the decrease in the calculation accuracy of the position and the orientation of the vehicle 10, 10v. This can reduce a possibility that the control signal is generated based on the sensor information having the possibility of reduced detection accuracy. Therefore, it is possible to prevent the vehicle 10, 10v from running on a route different from a desired running route.

### D-3. Other Embodiment 3

In the case where the vehicle 10, 10v is equipped with the in-vehicle LiDAR 161, and in at least one of the cases where the position difference is greater than or equal to the position threshold and where the direction difference is greater than or equal to the direction threshold, the calculation unit 117, 522 may stop calculation of the position and the orientation of the vehicle 10, 10v using the sensor information. In this manner, it is possible to stop calculation of the position and the orientation of the vehicle 10, 10v when there is a possibility of reduced detection accuracy of the sensor. This enables to avoid calculating the position and the orientation of the vehicle 10, 10v based on the sensor information having the possibility of reduced detection accuracy. Therefore, it is possible to avoid generating the running control signal based on the wrong position and orientation of the vehicle 10, 10v. Thus, it is possible to prevent the vehicle 10, 10v from running on a route different from a desired running route.

### D-4. Other Embodiment 4

In at least one of the cases where the position difference is greater than or equal to the position threshold and where the direction difference is greater than or equal to the direction threshold in the first case, the calculation unit 117, 522 may estimate a defective sensor. The calculation unit 117, 522 compares, for example, the position difference and the direction difference calculated from the sensor information of the in-vehicle LiDAR 161 and the external LiDAR 90 acquired at a plurality of different timings, thereby estimating the defective sensor. Then, the calculation unit 117, 522 may stop calculation of the position and the orientation of the vehicle 10, 10v using the sensor information from the sensor estimated to be defective, without stopping calculation of the position and the orientation of the vehicle 10, 10v using the sensor information from the sensor other than the sensor estimated to be defective. In such embodiment, it is possible to estimate which sensor is defective. This enables to continue calculation of the position and the orientation of the vehicle 10, 10v using the sensor information acquired by the sensor having the low possibility of reduced detection accuracy.

### D-5. Other Embodiment 5

In the case where the vehicle 10, 10v is equipped with the in-vehicle LiDAR 161, and in at least one of the cases where the position difference is greater than or equal to the position threshold and where the direction difference is greater than or equal to the direction threshold, the calculation device 5 may further include a notification control unit which notifies a user of specific information. The specific information is information indicating that there is a possibility of reduced detection accuracy of the sensor for acquiring the sensor information. When there is the possibility of reduced detection accuracy of the sensor, the notification control unit notifies the user of the specific information by, for example, causing a display device to display a message indicating the specific information, or causing a speaker to play sound indicating the specific information. In such embodiment, it is possible to quickly notify the user that there is the possibility of reduced detection accuracy of the sensor. This can reduce a possibility that the running control signal is generated based on the information having the possibility of reduced detection accuracy, or reduce the number of vehicle 10, 10v to be stopped upon receiving the stop control signal.

### D-6. Other Embodiment 6

The calculation device 5 may calculate only one of the position and the orientation of the vehicle 10, 10v. Even in such embodiment, at least one of the position and the orientation of the vehicle 10, 10v can be used as one piece of information in generating the running control signal.

### D-7. Other Embodiment 7

In each of the above first to third embodiments, the calculation device 5 selects the type of the sensor information to be used in calculating the position and the orientation of the vehicle 10, 10v based on the equipment information. On the contrary, the calculation device 5 may include a determination unit that determines whether or not the vehicle 10, 10v is equipped with the in-vehicle LiDAR 161 according to whether or not the in-vehicle LiDAR information can be acquired from the vehicle 10, 10v. In such embodiment, depending on whether or not the in-vehicle LiDAR information can be acquired, it is possible to select the type of the sensor information to be used in calculating the position and the orientation of the vehicle 10, 10v.

### D-8. Other Embodiment 8

In the calculation system 1, 1v, the function of the calculation device 5 may be realized by a plurality of devices. The calculation system 1, 1v may include, for example, the calculation device 5 including the acquisition unit 116, 521 and the calculation unit 117, 522, and a remote control device including the signal generation unit 118, 523 and the transmission unit 524. In this case, the calculation device 5 and the remote control device are provided at a different location from that of the vehicle 10, 10v. Even in such embodiment, according to mounted status of the in-vehicle LIDAR 161, it is possible to calculate the position and the orientation of the vehicle 10, 10v using the sensor information.

### D-9. Other Embodiment 9

A plurality of reference objects 8 may be installed in the vicinity of the track R. When the plurality of reference objects 8 is installed in the vicinity of the track R, a reflector may be attached to each reference object 8 with a different arrangement pattern such as a position, a range, and the number of attachment. In this manner, when the reference objects 8 are detected by the in-vehicle LiDAR 161 and the external LiDAR 90, a difference occurs in three-dimensional point cloud information indicative of each reference object 8 in the in-vehicle LiDAR information and the external LiDAR information. This enables the calculation device 5 to distinguish the plurality of reference objects 8 included in the in-vehicle LiDAR information and the external LiDAR information. Additionally, the calculation device 5 may distinguish the plurality of reference objects 8 based on, for example, positional relation (separation distance) between the position of the vehicle 10 and the absolute position of each reference object 8. In such embodiment, it is possible to calculate the position and the orientation of the vehicle 10 with the plurality of reference objects 8 having the known absolute position as an indicator. Therefore, it is possible to enhance the calculation accuracy of the position and the orientation of the vehicle 10, 10v.

### D-10. Other Embodiment 10

When using three-dimensional point cloud information as the external LiDAR information to calculate the position and the orientation of the vehicle 10, 10v, the calculation unit 117, 522 may acquire the vehicle position information as follows. In this case, the calculation unit 117, 522 may acquire the vehicle position information, for example, by template matching using the three-dimensional point cloud information as the external LiDAR information which is output from the external LiDAR 90 as detection results, as well as point cloud information for reference prepared in advance.

### D-11. Other Embodiment 11

In the above-described first embodiment and second embodiment, the calculation device 5 performs the processing from acquisition of vehicle location information to generation of a running control signal. By contrast, the vehicle 10 may perform at least part of the processing from acquisition of vehicle location information to generation of a running control signal. For example, embodiments (1) to (3) described below are applicable, for example.
(1) The calculation device 5 may acquire vehicle location information, determine a target location to which the vehicle 10 is to move next, and generate a route from a current location of the vehicle 10 indicated by the acquired vehicle location information to the target location. The calculation device 5 may generate a route to the target location between the current location and a destination or generate a route to the destination. The calculation device 5 may transmit the generated route to the vehicle 10. The vehicle 10 may generate a running control signal in such a manner as to cause the vehicle 10 to run along the route received from the calculation device 5 and control the actuator group 120 using the generated running control signal.
(2) The calculation device 5 may acquire vehicle location information and transmit the acquired vehicle location information to the vehicle 10. The vehicle 10 may determine a target location to which the vehicle 10 is to move next, generate a route from a current location of the vehicle 10 indicated by the received vehicle location information to the target location, generate a running control signal in such a manner as to cause the vehicle 10 to run along the generated route, and control the actuator group 120 using the generated running control signal.
(3) In the foregoing embodiments (1) and (2), an internal sensor may be mounted on the vehicle 10, and detection result output from the internal sensor may be used in at least one of the generation of the route and the generation of the running control signal. The internal sensor is a sensor mounted on the vehicle 10. The internal sensor can include, for example, a sensor for detecting a motion state of the vehicle 10, a sensor for detecting an operation state of each unit of the vehicle 10, and a sensor for detecting surrounding environment of the vehicle 10. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the calculation device 5 may acquire detection result from the internal sensor, and in generating the route, may reflect the detection result from the internal sensor in the route. In the foregoing embodiment (1), the vehicle 10 may acquire detection result from the internal sensor, and in generating the running control signal, may reflect the detection result from the internal sensor in the running control signal. In the foregoing embodiment (2), the vehicle 10 may acquire detection result from the internal sensor, and in generating the route, may reflect the detection result from the internal sensor in the route. In the foregoing embodiment (2), the vehicle 10 may acquire detection result from the internal sensor, and in generating the running control signal, may reflect the detection result from the internal sensor in the running control signal.

### D-12. Other Embodiment 12

In the above-described third embodiment, the vehicle 10v may be equipped with an internal sensor, and detection result output from the internal sensor may be used in at least one of generation of a route and generation of a running control signal. For example, the vehicle 10 may acquire detection result from the internal sensor, and in generating the route, may reflect the detection result from the internal sensor in the route. The vehicle 10 may acquire detection result from the internal sensor, and in generating the running control signal, may reflect the detection result from the internal sensor in the running control signal.

### D-13. Other Embodiment 13

In the above-described third embodiment in which the vehicle 10v can be running by autonomous control, the vehicle 10v acquires vehicle location information using detection result from the external sensor. 300 By contrast, the vehicle 10v may be equipped with an internal sensor, the vehicle 10v may acquire vehicle location information using detection result from the internal sensor, determine a target location to which the vehicle 10v is to move next, generate a route from a current location of the vehicle 10v indicated by the acquired vehicle location information to the target location, generate a running control signal for running along the generated route, and control the actuator group 120 using the generated running control signal. In this case, the vehicle 10 is capable of running without using any detection result from an external sensor. The vehicle 10v may acquire target arrival time or traffic congestion information from outside the vehicle 10v and reflect the target arrival time or traffic congestion information in at least one of the route and the running control signal. The functional configuration of the calculation system 1, 1v may be entirely provided at the vehicle 10v. Specifically, the processes realized by the calculation system 1, 1v in the present disclosure may be realized by the vehicle 10v alone. For example, the vehicle 10v equipped with the in-vehicle LiDAR 161 can single-handedly realize all the functions of the calculation system 1, 1v.

### D-14. Other Embodiment 14

In the above-described first embodiment, and second embodiment, the calculation device 5 automatically generates a running control signal to be transmitted to the vehicle 10. By contrast, the server 200 may generate a running control signal to be transmitted to the vehicle 10 in response to operation by an external operator existing outside the vehicle 10. For example, the external operator may operate an operating device including a display on which a captured image output from the external sensor 300 is displayed, steering, an accelerator pedal, and a brake pedal for operating the vehicle 10 remotely, and a communication device for making communication with the calculation device 5 through wire communication or wireless communication, for example, and the calculation device 5 may generate a running control signal responsive to the operation on the operating device. In this case, for example, the calculation device 5 may cause a display of an operating device to display the calculated position and orientation of the vehicle 10, thereby notifying an external operator.

### D-15. Other Embodiment 15

In each of the above-described embodiments, the vehicle 10, 10v is simply required to have a configuration to become movable by unmanned driving. The vehicle 10, 10v may embodied as a platform having the following configuration, for example. The vehicle 10, 10v is simply required to include at least actuators and a controller. More specifically, in order to fulfill three functions including “run,” “turn,” and “stop” by unmanned driving, the actuators may include vehicle control device 150, 150v and the sensor group 120. The vehicle 10, 10v is simply required to include the communication device further. Specifically, the vehicle 10, 10v to become movable by unmanned driving is not required to be equipped with at least some of interior components such as a driver's seat and a dashboard, is not required to be equipped with at least some of exterior components such as a bumper and a fender or is not required to be equipped with a bodyshell. In such cases, a remaining component such as a bodyshell may be mounted on the vehicle 10, 10v before the vehicle 10, 10v is shipped from a factory, or a remaining component such as a bodyshell may be mounted on the vehicle 10, 10v after the vehicle 10, 10v is shipped from a factory while the remaining component such as a bodyshell is not mounted on the vehicle 10, 10v. Each of components may be mounted on the vehicle 10, 10v from any direction such as from above, from below, from the front, from the back, from the right, or from the left. Alternatively, these components may be mounted from the same direction or from respective different directions. The location determination for the platform may be performed in the same way as for the vehicle 10, 10v in the first embodiments.

### D-16. Other Embodiment 16

The vehicle 10, 10v may be manufactured by combining a plurality of modules. The module means a unit composed of one or more components grouped according to a configuration or function of the vehicle 10, 10v. For example, a platform of the vehicle 10, 10v may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 10, 10v different from the platform may be modularized. Various modules may include an arbitrary exterior component such as a bumper or a grill, or an arbitrary interior component such as a seat or a console. Not only the vehicle 10, 10v but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.

### D-17. Other Embodiment 17

A configuration for realizing running of a vehicle by unmanned driving is also called a “Remote Control auto Driving system”. Conveying a vehicle using Remote Control Auto Driving system is also called “self-running conveyance”. Producing the vehicle using self-running conveyance is also called “self-running production”. In self-running production, for example, at least part of the conveyance of vehicles is realized by self-running conveyance in a factory where the vehicle is manufactured.

The present disclosure is not limited to the above-described embodiments, and can be implemented with various configurations without departing from the spirit and scope of the present disclosure. For example, the technical features of the embodiments corresponding to the technical features in each aspect described in the summary section can be replaced or combined as appropriate to solve some or all of the above-described problems, or achieve some or all of the above-described effects. Furthermore, the technical features can be deleted as appropriate unless described as essential in the present specification.

What is claimed is:

1. A calculation device, comprising:
an acquisition unit that acquires sensor information acquired by a sensor, and equipment information indicating whether or not a moving object movable by unmanned driving is equipped with an onboard distance measuring device as the sensor mounted on the moving object; and
a calculation unit that calculates at least one of a position and orientation of the moving object using the sensor information acquired by the acquisition unit,
wherein
in a first case where the moving object is equipped with the onboard distance measuring device, the calculation unit uses at least onboard distance measuring device information acquired by the onboard distance measuring device as the sensor information, thereby calculating at least one of the position and the orientation of the moving object, and
in a second case where the moving object is not equipped with the onboard distance measuring device, the calculation unit uses, as the sensor information, at least one of image information acquired by an external camera as the sensor installed in a different location from that of the moving object and external distance measuring device information acquired by an external distance measuring device as the sensor installed in a different location from that of the moving object, thereby calculating at least one of the position and the orientation of the moving object.

2. The calculation device according to claim 1, wherein
the acquisition unit further acquires calibration information indicating whether or not calibration of the onboard distance measuring device has been completed, and
in the first case,
when the calibration of the onboard distance measuring device has been completed, the calculation unit uses at least the onboard distance measuring device information as the sensor information, thereby calculating at least one of the position and the orientation of the moving object, and
when the calibration of the onboard distance measuring device has not been completed, the calculation unit uses at least one of the image information and the external distance measuring device information as the sensor information, thereby calculating at least one of the position and the orientation of the moving object without using the onboard distance measuring device information as the sensor information.

3. The calculation device according to claim 1, wherein
in the first case,
the acquisition unit acquires, in addition to the onboard distance measuring device information, at least one of the image information and the external distance measuring device information as the sensor information,
the calculation unit calculates at least one of the position and the orientation of the moving object using the onboard distance measuring device information as the sensor information, and calculates at least one of the position and the orientation of the moving object using at least one of the image information and the external distance measuring device information as the sensor information, and
the calculation unit stops calculation of the position and the orientation of the moving object using the sensor information in at least one of cases where (i) difference between the position of the moving object calculated using the onboard distance measuring device information and the position of the moving object calculated using at least one of the image information and the external distance measuring device information is greater than or equal to a predetermined position threshold, and (ii) difference between the orientation of the moving object calculated using the onboard distance measuring device information and the orientation of the moving object calculated using at least one of the image information and the external distance measuring device information is greater than or equal to a predetermined direction threshold.

4. The calculation device according to claim 1, further comprising:
a signal generation unit that generates a control signal to control operation of the moving object; and
a transmission unit that transmits the control signal generated by the signal generation unit to the moving object,
wherein in the first case,
the acquisition unit acquires, in addition to the onboard distance measuring device information, at least one of the image information and the external distance measuring device information as the sensor information,
the calculation unit calculates at least one of the position and the orientation of the moving object using the onboard distance measuring device information as the sensor information, and calculates at least one of the position and the orientation of the moving object using at least one of the image information and the external distance measuring device information as the sensor information, and
in at least one of cases where (i) difference between the position of the moving object calculated using the onboard distance measuring device information and the position of the moving object calculated using at least one of the image information and the external distance measuring device information is greater than or equal to a predetermined position threshold, and (ii) difference between the orientation of the moving object calculated using the onboard distance measuring device information and the orientation of the moving object calculated using at least one of the image information and the external distance measuring device information is greater than or equal to a predetermined direction threshold, the signal generation unit generates, as the control signal, any one of (a) a stop control signal to stop the moving object, and (b) a change control signal to change a destination to which the moving object moves by unmanned driving, from a predetermined target location to a maintenance site where at least one of a repair process to repair the onboard distance measuring device and a calibration process to calibrate the onboard distance measuring device is performed.

5. The calculation device according to claim 1, further comprising:
a notification control unit that notifies a user of specific information indicating that there is a possibility of reduced detection accuracy of the sensor,
wherein in the first case,
the acquisition unit acquires, in addition to the onboard distance measuring device information, at least one of the image information and the external distance measuring device information as the sensor information,
the calculation unit calculates at least one of the position and the orientation of the moving object using the onboard distance measuring device information as the sensor information, and calculates at least one of the position and the orientation of the moving object using at least one of the image information and the external distance measuring device information as the sensor information, and
the notification control unit notifies the user of the specific information in at least one of cases where (i) difference between the position of the moving object calculated using the onboard distance measuring device information and the position of the moving object calculated using at least one of the image information and the external distance measuring device information is greater than or equal to a predetermined position threshold, and (ii) difference between the orientation of the moving object calculated using the onboard distance measuring device information and the orientation of the moving object calculated using at least one of the image information and the external distance measuring device information is greater than or equal to a predetermined direction threshold.
